(19) United States
(12) Patent Application Publication
(10) Pub. No.: US 2026/0161679 A1
(43) Pub. Date: Jun. 11, 2026

(54) METHODS AND SYSTEMS FOR PREDICTING FIX ACTIONS FOR MALFUNCTIONING SYSTEMS

(71) Applicant: LEXMARK INTERNATIONAL, INC., LEXINGTON, KY (US)

(72) Inventors: CLINTON MICHAEL HERRON, BETHEL, OH (US); JEAN MARIE WHITNEY SIMMS, GEORGETOWN, KY (US); EMMA STOWE, LEXINGTON, KY (US)

(21) Appl. No.: 19/253,333

(22) Filed: Jun. 27, 2025

Related U.S. Application Data
(60) Provisional application No. 63/709,807, filed on Oct. 21, 2024.

(51) Int. Cl. G06F 16/3329; G06F 40/30; H04N 1/00

(52) U.S. Cl. CPC G06F 16/3329; G06F 40/30; H04N 1/00029

(57) ABSTRACT

There is provided a method (200) of producing a system for predicting a fix action for a malfunctioning system. The method comprises: providing ground truth data (210) comprising a plurality of sets of symptoms and solutions, each set corresponding to a respective historical fix event and each set comprising one or more symptoms of a respective system prior to the fix event and one or more solutions performed on the respective system during the fix event. The method further comprises: embedding the solutions of the ground truth data using a symmetric embeddings model (230) based on semantic meaning and grouping the embedded solutions into a predetermined set of solution groups using the embeddings. The method further comprises: training an asymmetric embeddings model (250) using the symptoms and their corresponding solution groups, the trained asymmetric embeddings model being configured to receive a query comprising symptoms of the malfunctioning system and output one or more of the predetermined solution groups as a predicted fix action for the malfunctioning system. There is further provided a method (300) of predicting a fix action for a malfunctioning system. There is further provided a method of fixing a malfunctioning system.

### CROSS REFERENCE TO RELATED APPLICATIONS

This application claims priority and benefit under 35 U.S.C. 119(e) from U.S. provisional application No. 63/709,807 titled “Creating and Training a Service Recommendation Model using Extracted and Refined Data,” having a filing date of Oct. 21, 2024.

### BACKGROUND

### 1. Technical Field

The present disclosure generally relates to methods and systems for predicting fix actions for malfunctioning systems, and, particularly but not exclusively, methods and systems for predicting fix actions for malfunctioning electronic and/or mechanical systems.

### 2. Description of the Related Art

It is common for systems to malfunction during use. While the system is malfunctioning, output from the system may be sub-standard, or the system may not function at all. Such down-time or sub-standard performance of a system causes reduced productivity. It is often possible to fix systems, for example by updating software or firmware, or by performing a mechanical fix, such as cleaning a component. However, determining the correct fix action for a system is often time-consuming and involves attempting many incorrect fix actions and finding the correct fix action through a long process of trial and error.

Accordingly, there is a need for improved systems and methods for predicting fix actions for malfunctioning systems, such as electronic and/or mechanical systems.

### SUMMARY

The present disclosure provides example methods and systems that may be implemented in any system, such as any electronic and/or mechanical system or specifically in an imaging/printing device/system to predict fix actions for malfunctioning systems.

There is provided a method of producing a prediction system for predicting a fix action for a malfunctioning system.

The method comprises: providing ground truth data comprising a plurality of sets of symptoms and solutions, each set corresponding to a respective historical fix event and each set comprising one or more symptoms of a respective system prior to the fix event and one or more solutions performed on the respective system during the fix event.

The method further comprises embedding the solutions of the ground truth data using a symmetric embeddings model based on semantic meaning. In this application, the term embedding is used to describe the determining of a vector representation. So, a vector representation is determined for each solution of the ground truth data using the symmetric embeddings model based on semantic meaning. The vector representations are therefore indicative of the semantic meaning of their respective solutions. Similar solutions, such as ‘cleared stuck page’ and ‘remove jammed sheet’ have vector representations that are relatively close to each other and dissimilar solutions such as ‘cleaned print head’ and ‘cleaned printer’ have vector representations that are relatively far from each other.

The method further comprises grouping the solutions into a set of solution groups using the embeddings. The inventors designed the method to use a symmetric embeddings model for grouping solutions to advantageously form clean groups from messy and/or noisy input data, such as free text. Large Language Models (LLMs) have previously been proposed for similar classification tasks, but the inventors have found that using the symmetric embeddings model improves speed, output and utilizes fewer resources.

In certain implementations, each solution group title is embedded and grouping comprises forming solution groups containing the nearest embedded solutions to the respective solution group title. In certain implementations, the nearest solutions are determined using a cosine similarity and a threshold. In certain implementations, solutions with a cosine similarity to a title of a respective solution group greater than the threshold will be grouped in the respective solution group. In certain implementations, some solutions may be assigned to more than one of the solution groups.

In certain implementations, the solution groups are predetermined solution groups. This advantageously reduces duplicate fix action predictions and reduces the likelihood of the prediction of unhelpful solutions.

The method further comprises training an asymmetric embeddings model using the symptoms and their corresponding solution groups, the trained asymmetric embeddings model being configured to receive a query comprising symptoms of the malfunctioning system and output one or more of the solution groups as a predicted fix action for the malfunctioning system.

The inventors have found that utilizing the asymmetric embeddings model gives improved predictions for fix actions in comparison with a non-ML statistical analysis approach. Using the same cleaned and grouped ground truth data, the inventors constructed a statistical analysis model and constructed the asymmetric embeddings model described above. The performance of the asymmetric embeddings model and the statistical model were evaluated using multiple accuracy metrics and the asymmetric embeddings model outperformed the statistical analysis model by between 13 and 45%, depending on the accuracy metric.

This improvement is seen even when the ground truth data is clean and categorized. The improvement is even greater when the ground truth data is messy and contains free text. An advantage of the use of the symmetric and asymmetric embeddings models is that these models are able to form models with accurate prediction results, even when the training data contains some errors. Using the embeddings model further prevents hallucination of the system.

In certain implementations, outputting one or more of the predetermined solution groups comprises ranking all of the solution groups and outputting the ranked list of solution groups, or a portion of the ranked list, such as a top portion. For example, a top 1, 2, 3, 4, 5 of the ranked list. In certain implementations, outputting one or more of the predetermined solution groups comprises outputting all solution groups with a similarity to the query greater than a similarity threshold. In certain implementations, the output solution groups are given in order of similarity to the query. In certain implementations, similarity is measured by cosine similarity. In certain implementations, the similarity threshold represents the confidence score threshold corresponding to the number of actual (ground truth) solutions for each test case. In certain implementations, for each sample in the training data, the confidence score of the solution that matches the number of correct solutions for the sample is collected. The median or average of these values is then calculated to give the similarity threshold. The threshold represents the typical confidence value at which the model has predicted as many solutions as there are correct answers. In certain implementations, the threshold is a cosine similarity of more than 0.7, preferably more than 0.8, preferably between 0.8 and 0.9. The similarity threshold is dependent on the training of the model and so will fluctuate between instances of training the model.

In certain implementations, the ground truth data comprises at least 50,000, or 100,000 sets of symptoms and solutions, preferably, at least 200,000 sets of symptoms and solutions, and/or less than 250,000 sets.

In certain implementations, fix events are where the fix performed was successful and the respective system was no longer malfunctioning after the fix event. In this application, the term historical means a real-world event occurring prior to the described method. The systems represented by the ground truth data are real-world systems. In certain implementations, the systems represented by the ground truth data are field, or edge systems, meaning that the systems were in use by users at the time of the respective fix event.

In certain implementations, the prediction system can predict fix actions for systems sharing a characteristic with the systems represented in the ground truth data. In certain implementations, the characteristic may be a system type and/or a common component, and/or a manufacturer, and/or a model number.

For example, the systems represented in the ground truth data may be imaging systems and the malfunctioning system may be an imaging system. In certain implementations, the malfunctioning system and the systems represented in the ground truth data are electronic systems, mechanical systems, and/or physical systems, such as an apparatus or device, or multiple connected apparatuses and/or devices which may be connected physically, and/or communicatively by a network. In certain implementations, the malfunctioning system and the systems represented in the ground truth data may each comprise a network and/or a software system which may be operating on one or more computers and/or servers, and/or as a cloud-based system. In certain implementations, the electronic systems may comprise medical and dental equipment, imaging devices, HVAC systems, industrial machines, heavy construction equipment, or biotech-related equipment.

In certain implementations, the symmetric embeddings model is fine-tuned for a type of the malfunctioning system. In certain implementations, the type of the malfunctioning system may be electronic, mechanical, medical and dental equipment, imaging devices, HVAC systems, industrial machines, heavy construction equipment, or biotech-related equipment. In certain implementations, the method comprises fine-tuning the symmetric embeddings model for the type of the malfunctioning system, preferably using language used to talk about the systems in the ground truth data.

In certain implementations, the solutions comprise text content, optionally structured text and/or free text content. In this specification, free text content is text that is unrestrained in length and/or content. It may be derived from a free text field in a database and/or form. Free text in the ground truth data may contain more than 50%, or more than 80% unique entries, meaning that the number of different entries is more than 50% or 80% of the total number of entries. In certain implementations, the solutions may also comprise parts to be replaced which may be indicated by part codes and/or structured text.

In certain implementations, the ground truth data may comprise structured solutions. In certain implementations, the structured solutions are a portion of the solutions and are embedded and grouped in the symmetric embeddings model as part of the solutions as described above.

Alternatively, the structured solutions may be in addition to the solutions and not embedded and grouped by the symmetric embeddings model as described above. The structured solutions may be considered as pre-grouped, due to their structured nature and may therefore be treated as additional solution groups after the solutions have been grouped. In certain implementations, the method may therefore comprise adding the structured solutions from the ground truth data to the solution groups, after the training of the symmetric embeddings model.

In certain implementations, providing ground truth data comprises extracting the solutions from fields in records of real-life system fix attempts. In certain implementations, the fields comprise a free text field. In certain implementations, extracting the solutions comprises using an LLM.

In certain implementations, the symptoms comprise text content, optionally structured text and/or free text content. In certain implementations, the symptoms may also comprise system-identified errors which may be indicated by error codes and/or structured text.

In certain implementations, at least a portion of the symptoms of the ground truth data are extracted from a free text field in records of real-life system fix attempts. In certain implementations, at least a portion of the symptoms of the ground truth data are extracted from a free text field in records of real-life system fix attempts using an LLM. In certain implementations, some symptoms may be extracted using non-ML techniques, for example, symptoms which comprise error codes and/or structured text.

In certain implementations, a set of symptoms for a system comprise an indication of the nature of the malfunction of the system. In certain implementations, the symptoms may further comprise system information such as a system type, family and/or function. In certain implementations, system information may be encoded in a model or serial number.

In certain implementations, the method further comprises: training the symmetric embeddings model using training data comprising triplet samples, each triplet sample comprising: (a) a sample from the ground truth data, (b) a positive extracted from the ground truth data, the positive being semantically similar to the sample, and (c) a negative semantically dissimilar to the sample. The sample, positive and negative may be phrases, acronyms, solutions and/or words.

In certain implementations, the sample, positive and negative are solutions, the negative solution is selected at random from all solutions in the ground truth data except the sample and positive. In certain implementations, the set of negative solutions comprises one or more hard negatives, the hard negatives having a different semantic meaning to the sample solution. For example, the term “reinstall” may be a hard negative for “install” as install will mean a new part will be required, but reinstall will not. For example, a HVPS (high voltage power supply) may be a hard negative of LVPS (low voltage power supply) and vice versa.

In certain implementations, the sample, positive and negative are solutions and the positive solution is selected from the ground truth data using machine-learning techniques and/or human subject matter experts. In certain implementations, semantically similar includes synonyms and phrases relating to the same action, and also may include similar actions which are not the same but have some similarity. For example, checking the incoming power is similar to measuring the voltage coming out of the wall outlet and checking the voltage going into the printer power supply. Further, clear paper path is semantically similar to remove paper clip from jam area and clear paper jam.

In certain implementations, the negative comprises a set of negative solutions and optionally includes at least 30, at least 50 or at least 60 negative solutions.

In certain implementations, training the asymmetric embeddings model comprises: using training data comprising triplet samples, each triplet sample corresponding to one of the sets of symptoms and solutions from the ground truth data, each triplet sample comprising: (a) a sample query comprising one or more symptoms from the respective set of symptoms and solutions, (b) one or more positive solution(s), the positive solution(s) comprising the solution group to which the solution of the respective set of symptoms and solutions belongs, and (c) a set of negative solutions comprising solution groups from the predetermined set of solution groups, other than the positive solution group.

In certain implementations, there may be more than one positive solution for each set of symptoms. In certain implementations, the positive solutions comprise a positive part-replacement solution and/or further positive solution groups which do not require part replacement.

In certain implementations, the solution groups in the set of negative solutions are selected at random from all solution groups except the positive solution group(s). In certain implementations, the set of negative solutions may also comprise negative part-replacement solutions. In certain implementations, negative part-replacement solutions may be selected from all part-replacement solutions not included in the positive solutions, optionally at random. In certain implementations, the set of negative solutions are selected from all solutions not in the positive solutions, all solutions comprise the solution groups and part-replacement solutions, optionally selected at random.

There is further provided the prediction system comprising the trained symmetric embeddings model and the trained asymmetric embeddings model as described above.

There is further provided, a method of predicting a fix action for a malfunctioning system. The method of predicting a fix action for a malfunctioning system comprises: receiving a query comprising symptoms of the malfunctioning system, embedding the symptoms of the malfunctioning system in a trained asymmetric embeddings model, the asymmetric embeddings model having been trained using a plurality of sets of ground truth symptoms and solution group(s), wherein the ground truth symptoms are from ground truth data comprising a plurality of sets of ground truth symptoms and solutions, each set corresponding to a respective historical fix event and each set comprising one or more symptoms of a respective system prior to the fix event and one or more solutions performed on the respective system during the fix event, and wherein solution groups are determined for each ground truth solution by embedding the solutions in the ground truth data using a symmetric embeddings model based on semantic meaning and grouping the solutions into a predetermined set of solution groups using the embeddings, and selecting one or more of the solution groups using the asymmetric embeddings model, the selected solution group(s) being the solution group(s) of the asymmetric embeddings model embedded closest to the symptoms, and predicting the fix action to be the one or more selected solution group(s).

In certain implementations, the symptoms of the query comprise text content, optionally structured text and/or free text content. In certain implementations, the query symptoms may also comprise system-identified errors which may be indicated by error codes and/or structured text.

In certain implementations, the query symptoms comprise an indication of the nature of the malfunction of the system. In certain implementations, the symptoms may further comprise system information such as a system type, family and/or, function. In certain implementations, system information may be encoded in a model or serial number.

In certain implementations, the malfunctioning system is an imaging system.

The method of predicting a fix action may utilize a prediction system produced using the above-described method of producing a prediction system for predicting a fix action for a malfunctioning system. The optional and essential features described above in relation to the method of producing a prediction system for predicting a fix action for a malfunctioning system apply as optional features to the method of predicting a fix action.

There is further provided a method of fixing a malfunctioning system, the method comprising: predicting a fix action for the system, according to the method described above and predicting the fix action to be one or more of the selected solution group(s), and performing the predicted fix action on the system.

There is further provided a computer-readable storage medium comprising instructions which, when executed by a computer, cause the computer to carry out the method of producing a prediction system for predicting a fix action for a malfunctioning system described above.

There is further provided a computer-readable storage medium comprising instructions which, when executed by a computer, cause the computer to carry out the method of predicting a fix action described above.

The methods and systems described above may be employed in any combination. The optional features described above are equally applicable to all of the described methods, systems and computer-readable media and are not limited to the particular method/system/computer-readable medium with which they are described. The essential features of any of the methods/systems/computer-readable media described may be optional features of any other method/system/computer-readable medium described. The methods may be computer-implemented and the systems may be computer systems.

From the foregoing disclosure and the following detailed description of various examples, it will be apparent to those skilled in the art that the present disclosure provides a significant advance in the art of predicting fix actions for malfunctioning systems. Additional features and advantages of various examples will be better understood in view of the detailed description provided below.

### BRIEF DESCRIPTION OF THE DRAWINGS

The above-mentioned and other features and advantages of the present disclosure, and the manner of attaining them, will become more apparent and will be better understood by reference to the following description of examples taken in conjunction with the accompanying drawings. Like reference numerals are used to indicate the same element throughout the specification.

FIG. 1 is a flow chart showing a method of producing a system for predicting fix actions for malfunctioning systems;

FIG. 2 is a flow chart showing a method of predicting fix actions for malfunctioning systems, using the system produced in the method of FIG. 1;

FIG. 3 is a flow chart showing a portion of the method of FIG. 1 in more detail;

FIG. 4 is a flow chart showing a portion of the method of FIG. 1 in more detail;

FIG. 5 is a flow chart showing a portion of the method of FIG. 1 in more detail;

FIG. 6 is a flow chart showing a portion of the method of FIG. 1 in more detail;

FIG. 7 is a flow chart showing the method of FIG. 2 in more detail;

FIG. 8 is a diagrammatic view of an imaging system.

### DETAILED DESCRIPTION OF THE DRAWINGS

It is to be understood that the disclosure is not limited to the details of construction and the arrangement of components set forth in the following description or illustrated in the drawings. The disclosure is capable of other examples and of being practiced or of being carried out in various ways. For example, other examples may incorporate structural, chronological, process, and other changes. Examples merely typify possible variations. Individual components and functions are optional unless explicitly required, and the sequence of operations may vary. Portions and features of some examples may be included in or substituted for those of others. The scope of the disclosure encompasses the appended claims and all available equivalents. The following description is, therefore, not to be taken in a limited sense, and the scope of the present disclosure is defined by the appended claims.

Also, it is to be understood that the phraseology and terminology used herein is for the purpose of description and should not be regarded as limiting. The use herein of “including,” “comprising,” or “having” and variations thereof is meant to encompass the items listed thereafter and equivalents thereof as well as additional items. Further, the use of the terms “a” and “an” herein do not denote a limitation of quantity but rather denote the presence of at least one of the referenced item.

In addition, it should be understood that examples of the disclosure include both hardware and electronic components or modules that, for purposes of discussion, may be illustrated and described as if the majority of the components were implemented solely in hardware.

It will be further understood that each block of the diagrams, and combinations of blocks in the diagrams, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus may create means for implementing the functionality of each block or combinations of blocks in the diagrams discussed in detail in the description below.

These computer program instructions may also be stored in a non-transitory computer-readable medium that may direct a computer or other programmable data processing apparatus to function in a particular manner, such that the instructions stored in the computer-readable medium may produce an article of manufacture, including an instruction means that implements the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the functions specified in the block or blocks.

Accordingly, blocks of the diagrams support combinations of means for performing the specified functions, combinations of steps for performing the specified functions and program instruction means for performing the specified functions. It will also be understood that each block of the diagrams, and combinations of blocks in the diagrams, can be implemented by special purpose hardware-based computer systems that perform the specified functions or steps or combinations of special purpose hardware and computer instructions.

Disclosed are example methods for producing a prediction system for predicting fix actions for malfunctioning systems and example methods and prediction systems for predicting fix actions for malfunctioning systems.

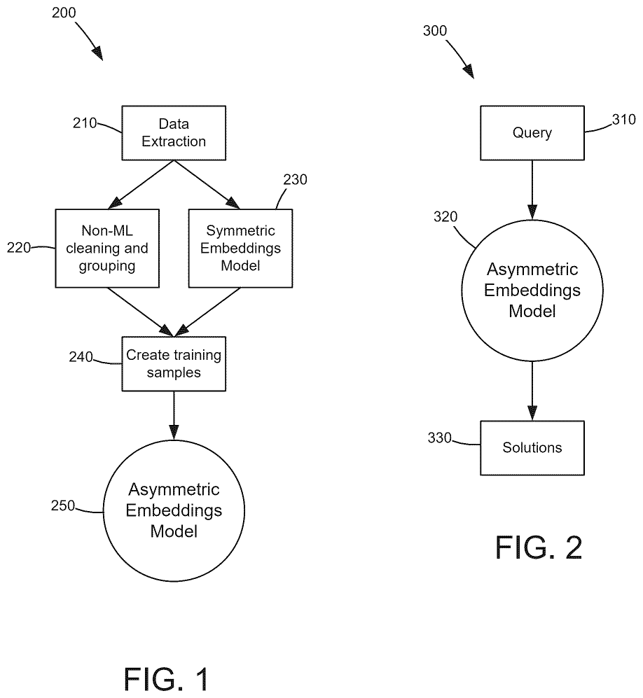

FIG. 1 shows a method 200 of producing a prediction system for predicting a fix action for a malfunctioning system.

At step 210, ground truth data is provided, the ground truth data comprising a plurality of sets of symptoms and solutions. Each set corresponds to a respective one of the historical fix events and each set comprising one or more symptoms of a respective system prior to the fix event and one or more solutions performed on the respective system during the fix event. The ground truth data is extracted from records of the historical fix events.

At step 220, symptom and structured solution data within the ground truth data is cleaned.

At step 230, free text solutions in the ground truth data are embedded using a symmetric embeddings model based on semantic meaning. A vector representation is determined for each solution of the ground truth data using the symmetric embeddings model based on semantic meaning. The free text solutions are then each grouped into one or more solution groups using the embeddings.

At step 240, training data is formed using the symptoms cleaned at step 220 and their corresponding solution groups from step 230 and structured solutions from step 220.

At step 250, an asymmetric embeddings model is trained using training data from step 240. The trained asymmetric embeddings model is configured to receive a query comprising symptoms of the malfunctioning system and output one or more of the solution groups from step 230 and/or one or more structured solutions from step 220 as a predicted fix action for the malfunctioning system.

The resulting prediction system can predict fix actions for systems sharing a characteristic with the systems represented in the ground truth data. The prediction system comprises the trained asymmetric embeddings model as described above and a database of vector representations of the solutions including the solution groups and the structured solutions.

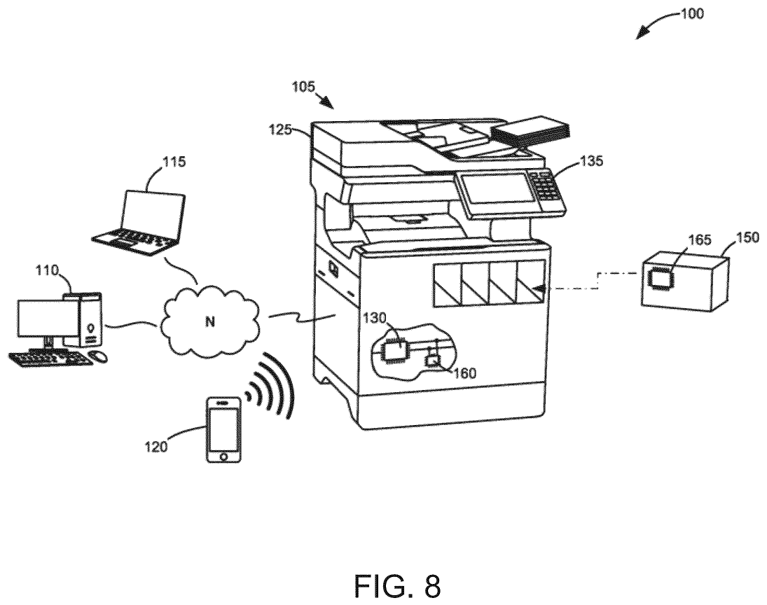

In one example, the systems represented in the ground truth data are imaging systems, such as the imaging system shown in FIG. 8 and the malfunctioning system is also an imaging system such as the imaging system shown in FIG. 8. It will be recognized that in other embodiments, the malfunctioning system and the systems represented in the ground truth data may be any other type of electronic system, and/or physical system, such as an apparatus or device, or multiple connected apparatuses and/or devices which may be connected physically, and/or communicatively by a network.

FIG. 2 shows a method of predicting a fix action utilizing the prediction system produced using the method of FIG. 1. A query comprising symptoms of the malfunctioning system is received at step 310. At step 320, the query is embedded in the trained asymmetric embeddings model produced at step 250 of FIG. 1.

The asymmetric embeddings model provides a predicted fix action at step 330, the predicted fix action being one or more of the solution groups and/or structured solutions embedded closest to the query.

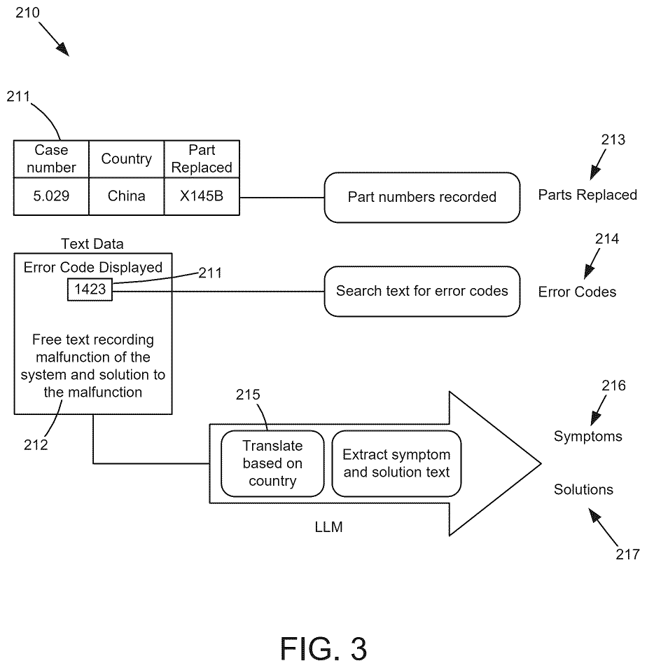

Step 210 of FIG. 1 is shown in more detail in FIG. 3. Ground truth data contains a plurality of sets of symptoms and solutions. Each set corresponds to a respective one of historical fix events and each set comprises one or more symptoms of a respective system prior to the fix event and one or more solutions performed on the respective system during the fix event. The ground truth data is extracted from records of the historical fix events. Fix events are where the fix performed was successful and the respective system was no longer malfunctioning after the fix event. Where available data includes non-fix events in which the respective malfunctioning system was not successfully fixed, these non-fix events are filtered from the data.

An example sample of ground truth data is shown in FIG. 3 and includes structured data 211 and free text 212.

The ground truth data comprises between 200,000 and 250,000 sets of symptoms and solutions.

The structured data includes a part replacement code “X145B”, and an error code “1423”. The part replaced is extracted from a part-replacement field and stored as a structured solution 213. Structured text associated with the part replacement code may also be retrieved from a database and stored as a solution. The error code is extracted from a free text field by searching the free text field for structured data, such as error codes and part numbers and stored as a symptom. The structured solutions 213 and structured symptoms 214 are extracted using non-ML techniques, such as a data extraction software tool.

The free text 212 is transformed using an LLM, such as Mistral 7B. In the case of this sample, the language is not the language selected for training the models, so the free text is first translated 215 by the LLM to the chosen language of English. The translation may be automatically detected by the LLM, or may be determined from structured data, such as the recorded country in structured data 211. Once translated, symptoms 216 and solutions 217 are extracted from the free text 212 by the LLM.

The set of symptoms include an indication of the nature of the malfunction by way of the error code and the free text description of the symptoms. Further, the symptoms include system information encoded in a model number. This enables information such as a system type, family and functionality to effectively be included in the symptoms.

In step 220 of FIG. 1, cleaning and grouping is carried out on the symptoms and structured solutions.

The part replacement codes are grouped into similar groups. For example, all part replacement codes relating to replacements of different models of same components may be grouped together to a common solution of “Replace X component”. For example, where the component is a fuser, different specifications of fusers may be used in different imaging systems, so many different part replacement codes may indicate a replaced fuser. All part replacement codes referring to a fuser may be grouped into the common “Replace fuser” solution.

Structured text associated with an error code symptom may also be retrieved from a database and stored as a symptom.

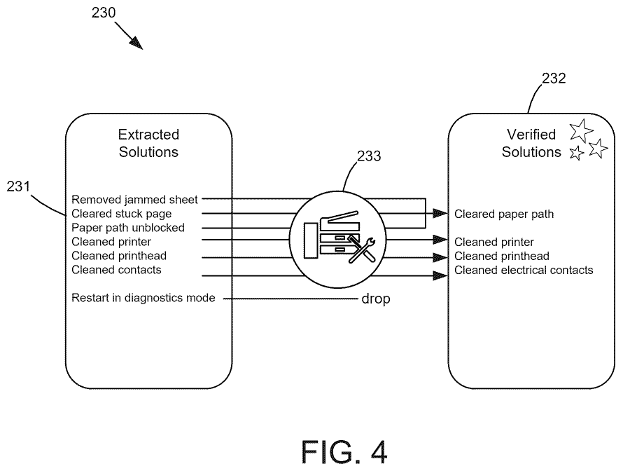

Step 230 of FIG. 1 comprises embedding the solutions of the ground truth data using a symmetric embeddings model based on semantic meaning. This step is shown in more detail in FIG. 4.

The symmetric embeddings model is fine-tuned for the type of the malfunctioning system. In the illustrated example, the system is an imaging system so the symmetric embeddings model is fine-tuned for imaging systems. In other words, the symmetric embeddings model is pre-trained to understand semantic meaning of imaging device terminology.

The symmetric embeddings model is trained using training data comprising triplet samples. Each triplet sample includes: (a) a sample from the ground truth data, (b) a positive extracted from the ground truth data, the positive being semantically similar to the sample, and (c) a negative semantically dissimilar to the sample. Triplet training causes the model to maximize the distance between the sample and their corresponding negative and to minimize the distance between the sample and the corresponding positive, for all the training data. Each set of sample, positive and negative may be one of: phrases, acronyms, solutions and/or words.

For triplets where the sample, positive and negative are solutions, the negative comprises a set of solutions selected at random from all solutions in the ground truth data except the positive solution(s). In one example, the set of negative solutions also includes one or more hard negatives, the hard negatives having a different semantic meaning to the sample solution, or the positive solution. In this example, there are 150 negative solutions for each sample solution.

The positive solution may be a set of positive solutions and is selected from the ground truth data using machine-learning techniques and/or human subject matter experts. The set of positive solutions are semantically similar to the sample solution.

After training, a vector representation is determined for each free text solution 231 of the ground truth data using the symmetric embeddings model based on semantic meaning. The vector representations are therefore indicative of the semantic meaning of their respective solutions. Similar solutions, such as ‘cleared stuck page’ and ‘remove jammed sheet’ have vector representations that are relatively close to each other and dissimilar solutions such as ‘cleaned print head’ and ‘cleaned printer’ have vector representations that are relatively far from each other.

Each predetermined solution group title is then embedded using the trained symmetric embeddings model. The free text solutions are then grouped by forming solution groups 232 containing the nearest embedded solutions to the respective solution group title.

The nearest solutions are determined using a cosine similarity and a threshold. Solutions with a cosine similarity to a title of a solution group greater than the threshold will be grouped in the respective solution group. Some solutions may have cosine similarities higher than the threshold for more than one solution group title, and these solutions are assigned to all solution groups for which their cosine similarity reaches the threshold. In alternative examples, each solution may be assigned only to the solution group for which they have the highest cosine similarity.

The inventors have carefully designed the method to use a symmetric embeddings model for grouping solutions to advantageously form clean groups from messy and/or noisy input data, such as free text. Large Language Models (LLMs) have previously been proposed for similar classification tasks, but the inventors have found that using the symmetric embeddings model improves speed, output and utilizes fewer resources and is not prone to hallucinations.

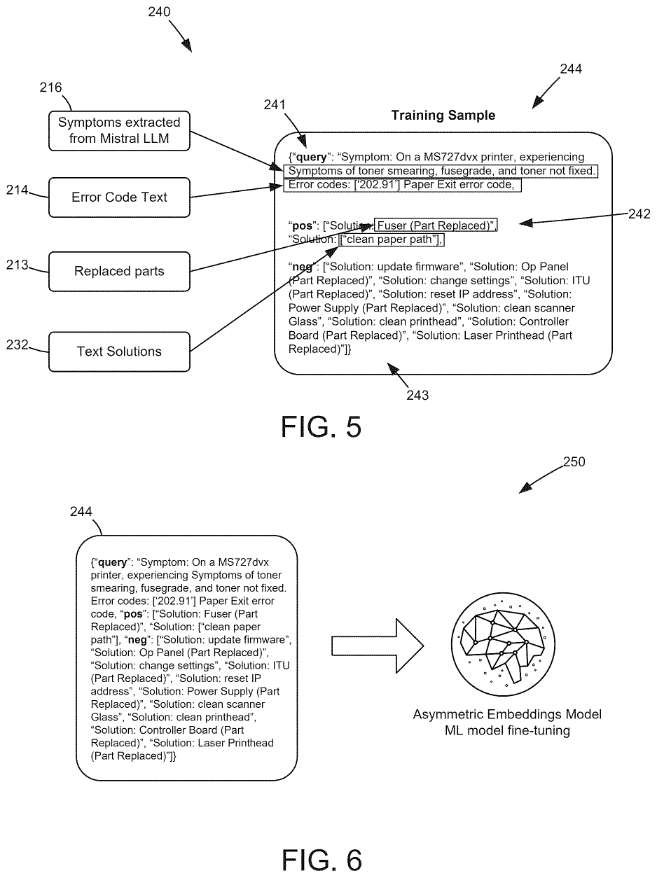

FIG. 5 shows the process for forming training data for an asymmetric embeddings model. The trained asymmetric embeddings model is configured to receive a query comprising symptoms of the malfunctioning system and output one or more of the solution groups as a predicted fix action for the malfunctioning system.

To form the training data, the cleaned symptoms 214, 216, the structured solutions 213 and the solution groups 232 are formed into training data samples for training an asymmetric embeddings model. Each training data sample includes a triplet sample including: a sample query 241 formed of the symptoms 214, 216 from a respective set of ground truth data, a positive set 242 formed of the structured solutions 213 and solution groups 232 from the respective set of ground truth data and a negative set 243 formed of solution groups from the predetermined set of solution groups 232, other than those appearing in the positive set and structured solutions 213 other than those appearing in the positive set.

The query includes free text symptoms which have not been grouped. This advantageously means that the trained model is capable of determining solutions for free text queries and does not require the user to input symptoms in a structured manner.

As shown in the example of FIG. 5, there may be more than one positive solution for each set of symptoms. In this example training sample, the positive solutions 242 comprise a positive structured solution 213 including a part to be replaced (“Fuser (Part Replaced)”)and a positive solution group 232 (“clean paper path”).

The set of negative solutions 243 are selected from all solution groups and grouped structured solutions from the ground truth data, except those in the positive solutions 242. The negative solution groups in the illustrated example include “update firmware” and “change settings”, and the set of negative solutions 243 also includes structured solutions, such as “Power Supply (Part Replaced)”.

The set of negative solutions are selected at random. The inventors have designed the training by selecting the negative solutions at random, rather than selecting closest solutions from the positive solutions (for example by using a set of negative solutions closest to but not the same as the positive solutions in the symmetric embeddings model). The inventors have found that this random selection of the negative set of solutions improves the accuracy of the resulting model.

As illustrated in FIG. 6, an asymmetric embeddings model is trained 250 using the training samples 244 and triplet training.

The trained asymmetric embeddings model is configured to receive a query comprising symptoms of the malfunctioning system and output one or more of the solution groups as a predicted fix action for the malfunctioning system and further one or more structures solutions, such as part-replacement solutions.

Triplet training causes the model to maximize the distance between the sample query and their corresponding negative solutions and to minimize the distance between the sample query and the corresponding positive solutions, for all the training data.

A database of vector representations of all of the structured solutions and solution groups is created from the trained model.

The inventors have found that utilizing the asymmetric embeddings model gives improved predictions for fix actions in comparison with a non-ML statistical analysis approach. Using the same cleaned and grouped ground truth data, the inventors constructed a statistical analysis model and constructed the asymmetric embeddings model described above. The performance of the asymmetric embeddings model and the statistical model were evaluated using multiple metrics and the asymmetric embeddings model outperformed the statistical analysis model by between 13 and 45%, depending on the evaluation metric.

The asymmetric embeddings model is configured to embed a received query to produce a vector representation of the query and then to rank all of the solution groups and structured solutions in the vector database, from the solution group or structured solution with the closest embedding to the query to the solution group or structured solution with the farthest embedding from the query. The distance between the query and each solution is determined by cosine similarity.

The model may then output the ranked list, or a portion of the ranked list, such as a top portion. For example, a top 1, 2, 3, 4, 5 of the ranked list.

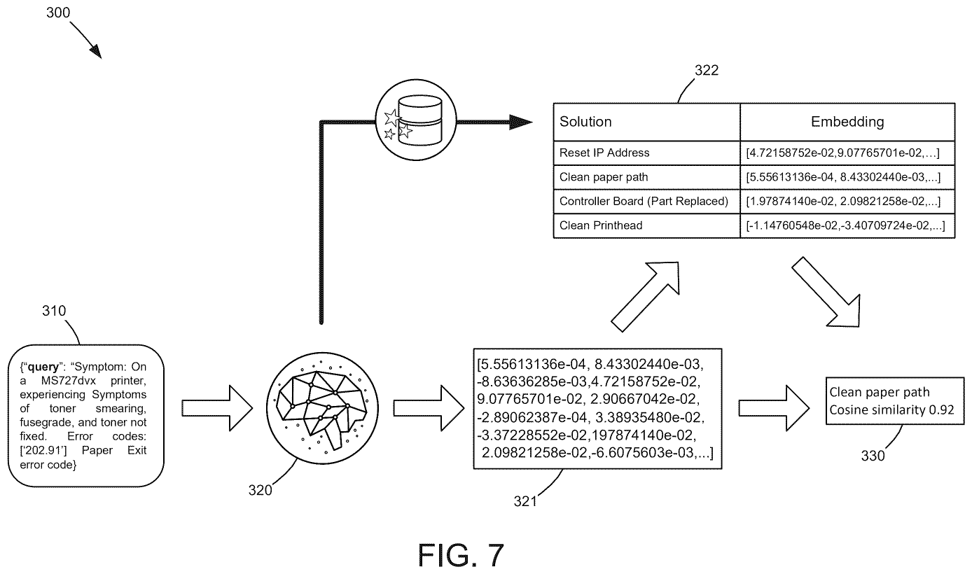

FIG. 7 shows a diagram of a method 300 of using the trained asymmetric embeddings model to predict a fix action for a malfunctioning system.

The query 310 comprises symptoms of the malfunctioning system. The symptoms include an indication of the malfunction and system information. The indication of the malfunction in this example includes free text: “experiencing symptoms of toner smearing, fusegrade, and toner not fixed” along with structured symptoms: “Error codes: [‘202.91’] Paper Exit error code”. The system information is given in free text: “On a MS725dvn printer” which indicates the model number of the system, thereby encoding information about the type, components and functionality of the system.

At step 320, the query is embedded in the trained asymmetric embeddings model and a vector representation 321 of the query is generated.

The vector database 322 including all of the solution groups and structured solutions is compared with the vector representation of the query to rank the solution groups and structured solutions from closest to farthest from the query embedding. Then, the top portion of the ranking is selected, including one or more of the solution groups. In this case, the selected solution group is “Clean paper path” with a cosine similarity of 0.92.

The model predicts the fix action to be “Clean paper path”.

The predicted fix action can then be performed to fix the system. Where the predicted fix action may be performed automatically (for example, adjust settings or update firmware), this may be performed automatically.

Referring to FIG. 8, there is shown a diagrammatic view of an imaging system 100 used in association with the present disclosure. When imaging system 100 experiences a malfunction, the imaging system may produce an error code associated with the malfunction, the imaging system may determine other symptoms such as high temperatures, or issues with image quality and/or a user may notice symptoms of malfunction, such as image smearing. When the imaging system 100 determines a symptom of a malfunction, the symptom(s) may be sent to a system as described above for predicting a fix action. The symptoms may be sent automatically by the imaging system or by a user.

The methods and systems described above to predict a fix action can be utilized to determine the fix action required to return the imaging system 100 to normal operation. Further, when the predicted fix action includes a task that may be performed automatically, such as updating firmware, this may be performed automatically, without user involvement.

Imaging system 100 includes an imaging device 105 used for printing images on sheets of media. Image data of the image to be printed on a media sheet may be supplied to imaging device 105 from a variety of sources such as a computer 110, laptop 115, mobile device 120, scanner 125 of the imaging device 105, or like computing device. The sources directly or indirectly communicate with imaging device 105 via wired and/or wireless connections.

Imaging device 105 includes an imaging device component 130 and a user interface 135. The imaging device controller may include component 130 which may include a processor and associated memory. In some examples, imaging device component 130 may be formed as one or more Application Specific Integrated Circuits (ASICs) or System-on-Chip (SoCs). Memory may be any memory device which stores data and may be used with or capable of communicating with processor. For example, memory may be any volatile or non-volatile memory or combination thereof such as, for example, random access memory (RAM), read-only memory (ROM), flash memory and/or non-volatile RAM (NVRAM) for storing data. Optionally, imaging device component 130 may control the processing of print data. Optionally, imaging device component 130 may also control the operation of a print engine during printing of an image onto a sheet of media.

In one example, imaging device 105 may employ an electronic authentication scheme to authenticate consumable supply items and/or replaceable units installed in imaging device 105. In FIG. 8, a representative consumable supply item/replaceable item, such as a toner cartridge 150, is shown (other consumable/replaceable supply items can equally be used in addition or instead, such as imaging units and fusers). Supply item 150 may be installed in a corresponding storage area in imaging device 105.

The above has been described in relation to a specific implementation/embodiment. However, modifications can be implemented within the scope of the application.

Relatively apparent advantages of the many embodiments include, but are not limited to, providing a prediction system/method to predict a fix action for a malfunctioning system.

It will be understood that the example applications described herein are illustrative and should not be considered limiting. It will be appreciated that the actions described and shown in the example flowcharts may be carried out or performed in any suitable order. It will also be appreciated that not all of the actions described in FIGS. 1 to 7 need to be performed in accordance with the example embodiments of the disclosure and/or additional actions may be performed in accordance with other example embodiments of the disclosure. It will be appreciated that the methods and systems for predicting a fix action may be performed for any type of system such as any electronic system, and the invention is not limited to use with the imaging system described above.

Many modifications and other embodiments of the disclosure set forth herein will come to mind to one skilled in the art to which these disclosures pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of producing a system for predicting a fix action for a malfunctioning system, the method comprising:
providing ground truth data comprising a plurality of sets of symptoms and solutions, each set corresponding to a respective historical fix event and each set comprising one or more symptoms of a respective system prior to the fix event and one or more solutions performed on the respective system during the fix event,
embedding the solutions of the ground truth data using a symmetric embeddings model based on semantic meaning,
grouping the embedded solutions into a predetermined set of solution groups using the embeddings,
training an asymmetric embeddings model using the symptoms and their corresponding solution groups, the trained asymmetric embeddings model being configured to receive a query comprising symptoms of the malfunctioning system and output one or more of the predetermined solution groups as a predicted fix action for the malfunctioning system.

2. The method of claim 1, wherein the symmetric embeddings model is fine-tuned for a type of the malfunctioning system.

3. The method of claim 1, wherein the solutions comprise free text content.

4. The method of claim 3, wherein providing ground truth data comprises extracting the solutions from free text fields in records of real-life system fix attempts.

5. The method of claim 4, wherein extracting the solutions comprises using an LLM.

6. The method of claim 1, wherein the symptoms comprise free text content.

7. The method of claim 6, wherein at least a portion of the symptoms of the ground truth data are extracted from a free text field in records of real-life system fix attempts, using an LLM.

8. The method of claim 1, wherein the symptoms comprise system information such as a system type, family, function.

9. The method of claim 1, the method further comprising:
training the symmetric embeddings model using training data comprising triplet samples, each triplet sample comprising:
a sample solution from the ground truth data,
a set of positive solutions extracted from the ground truth data, the positive solutions being semantically similar to the sample solution, and
a set of negative solutions semantically dissimilar to the solution,
wherein the set of negative solutions comprises solutions selected at random from all solutions in the ground truth data except the positive solutions.

10. The method of claim 1, wherein training the asymmetric embeddings model comprises:
using training data comprising triplet samples, each triplet sample corresponding to one of the sets of symptoms and solutions from the ground truth data, each triplet sample comprising:
a sample query comprising one or more symptoms from the respective set of symptoms and solutions,
one or more positive solution(s), the positive solution(s) comprising the solution group to which the solution of the respective set of symptoms and solutions belongs, and
a set of negative solutions comprising solution groups from the predetermined set of solution groups, other than the positive solution group.

11. The method of claim 10, wherein the solution groups in the set of negative solutions are selected at random from all solution groups in the ground truth data except the positive solution group(s).

12. The method of claim 1, wherein the system is an imaging system.

13. A method of predicting a fix action for a malfunctioning system comprising:
receiving a query comprising symptoms of the malfunctioning system,
embedding the symptoms of the malfunctioning system in a trained asymmetric embeddings model, the asymmetric embeddings model having been trained using a plurality of sets of ground truth symptoms and solution group(s),
wherein the ground truth symptoms are from ground truth data comprising a plurality of sets of ground truth symptoms and solutions, each set corresponding to a respective historical fix event and each set comprising one or more symptoms of a respective system prior to the fix event and one or more solutions performed on the respective system during the fix event, and
wherein solution groups are determined for each ground truth solution by embedding the solutions in the ground truth data using a symmetric embeddings model based on semantic meaning and grouping the solutions into a predetermined set of solution groups using the embeddings, and
selecting one or more of the solution groups using the asymmetric embeddings model, the selected solution group(s) being the solution group(s) of the asymmetric embeddings model embedded closest to the symptoms, and
predicting the fix action to be the one or more selected solution group(s).

14. The method of claim 12, wherein the symptoms of the query comprise free text content.

15. The method of claim 12, wherein the symptoms comprise system information such as a system type, family, function.

16. The method of claim 12, wherein the system is an imaging system.

17. A method of fixing a malfunctioning system, the method comprising:
predicting a fix action for the system, by:
receiving a query comprising symptoms of the malfunctioning system,
embedding the symptoms of the malfunctioning system in a trained asymmetric embeddings model, the asymmetric embeddings model having been trained using a plurality of sets of ground truth symptoms and solution group(s),
wherein the ground truth symptoms are from ground truth data comprising a plurality of sets of ground truth symptoms and solutions, each set corresponding to a respective historical fix event and each set comprising one or more symptoms of a respective system prior to the fix event and one or more solutions performed on the respective system during the fix event, and
wherein solution groups are determined for each ground truth solution by embedding the solutions in the ground truth data using a symmetric embeddings model based on semantic meaning and grouping the solutions into a predetermined set of solution groups using the embeddings, and
selecting one or more of the solution groups using the asymmetric embeddings model, the selected solution group(s) being the solution group(s) of the asymmetric embeddings model embedded closest to the symptoms, and
predicting the fix action to be one or more of the selected solution group(s), and
performing the fix action on the system.

18. The method of claim 17, wherein the system is an imaging system.

19. A computer-readable storage medium comprising instructions which, when executed by a computer, cause the computer to carry out the steps of the method of claim 1.

20. A computer readable storage medium comprising instructions which, when executed by a computer, cause the computer to carry out the method of claim 12.
